(19) United States
(12) Patent Application Publication
(10) Pub. No.: US 2014/0283553 A1
(43) Pub. Date: Sep. 25, 2014

(54) METHOD OF MANUFACTURING COVER GLASS PLATE

(71) Applicant: KONICA MINOLTA, INC., TOKYO (JP)

(72) Inventor: Toshiya Tomisaka, Yao-shi (JP)

(73) Assignee: KONICA MINOLTA, INC., TOKYO (JP)

(21) Appl. No.: 14/357,889

(22) PCT Filed: Sep. 21, 2012
(86) PCT No.: PCT/JP2012/074171

§ 371 Date: May 13, 2014

(30) Foreign Application Priority Data
Dec. 15, 2011 (JP) 2011-274281

(51) Int. Cl. C03B 11/08

(52) U.S. Cl. CPC C03B 11/082; C03B 2215/41
USPC 65/61; 65/90

(57) ABSTRACT

Method of manufacturing cover glass plate includes drop step, press step and processing step. In the drop step, molten glass is dropped onto lower mold. In the press step, the molten glass on the lower mold is pressed with upper mold having concave portion so as to fill the concave portion of the upper mold with the molten glass and furthermore, the concave portion is overlapped to area between the upper mold and the lower mold so as to form preform formed with molded main body having first surface to which the shape of the concave portion of the upper mold is transferred and overlap portion having second surface which is portion other than the molded main body and to which the shape of the lower mold is transferred. In the processing step, all the overlap portion is removed from the preform.

### TECHNICAL FIELD

The present invention relates to a method of manufacturing a cover glass plate, and more particularly relates to, for example, a method of manufacturing a cover glass plate provided on the image display surface of a smartphone.

### BACKGROUND ART

In a digital device (such as a mobile telephone, a smartphone or a mobile computer) having an image display function, a cover glass plate for protecting its image display surface is generally provided. The cover glass plate is manufactured by cutting a plate glass molded in the shape of a flat plate and having a large area to a predetermined size. Hence, after the cutting of the plate glass, it is necessary to perform external frame processing thereon. Specifically, external frame processing for smoothly chamfering or rounding the boundary of the side surfaces of the four corners and the four sides of a rectangular plate glass is needed (for example, see patent document 1). Although in recent years, there have been growing needs for changing, in specifications, the surface of a cover glass plate from a flat surface to a curved surface, in order to change the surface of the plate glass molded in the shape of a flat plate into a curved surface, it is necessary to perform post-processing.

### RELATED ART DOCUMENT

### Patent Document

Patent document 1: JP-A-2009-280452

### DISCLOSURE OF THE INVENTION

### Problems to be Solved by the Invention

However, when the external frame processing on the cover glass plate or the post-processing on the surface of the cover glass plate is performed, the manufacturing process is increased or complicated, with the result that the cost is increased.

The present invention is made in view of the foregoing conditions; an object thereof is to provide a method of manufacturing a cover glass plate that allows a cover glass plate having an arbitrary external frame shape and an arbitrary surface shape to be easily manufactured without external frame processing on the cover glass plate and post-processing on the surface of the cover glass plate being performed.

### Means for Solving the Problem

To achieve the above object, according to the present invention, there is provided a method of manufacturing a cover glass plate, the method including: a drop step of dropping molten glass onto a lower mold; a press step of pressing the molten glass on the lower mold with an upper mold having a concave portion so as to fill the concave portion of the upper mold with the molten glass and of overlapping the concave portion to an area between the upper mold and the lower mold so as to form a preform formed with a molded main body having a first surface to which a shape of the concave portion of the upper mold is transferred and an overlap portion having a second surface which is a portion other than the molded main body and to which a shape of the lower mold is transferred; and a processing step of removing all the overlap portion from the preform.

Preferably, in the press step, an upper surface and a side surface of the cover glass plate are formed with the concave portion of the upper mold, and in the processing step, surface grinding or surface polishing is performed on the second surface so as to form a lower surface of the cover glass plate.

Preferably, in the press step, the lower mold has a concave portion, and a concave portion and a convex portion are formed in the second surface of the overlap portion.

Preferably, in the press step, the convex portion is provided in an outermost circumference of the second surface.

Preferably, an area of the convex portion on the second surface is one-fourth or more the entire second surface.

Preferably, in the press step, the rectangular concave portion is provided in the second surface, and the convex portion is provided over an entire region of the outermost circumference of the second surface so as to surround the concave portion.

Preferably, a shape of the concave portion of the second surface is a circular shape, a square shape, a honeycomb shape or a mesh shape.

Preferably, the area of the convex portion on the second surface is one-half or less an area of the concave portion on the second surface.

Preferably, a side surface of the concave portion of the second surface has a draft taper shape of three degrees or more with respect to a normal to a bottom surface of the concave portion.

Preferably, a surface shape of a part or a whole of the concave portion of the upper mold is curved, and a surface shape of a part or a whole of the first surface is curved.

Preferably, in the press step, a surface of the upper mold in contact with the overlap portion is roughened as compared with a surface of the concave portion of the upper mold.

Preferably, in the press step, an external mold is arranged between the upper mold and the lower mold, and spread of the overlap portion is restricted by the external mold.

### Advantages of the Invention

Since the external frame shape of the cover glass plate is determined by the concave portion of the upper mold, when all the overlap portion is removed from the preform by the surface grinding or the surface polishing in the processing step, it is not necessary to perform external frame processing on the cover glass plate. Moreover, since the surface shape of the cover glass plate is also determined by the concave portion of the upper mold, it is not necessary to perform post-processing on the surface of the cover glass plate. Hence, in the present invention, it is possible to easily manufacture the cover glass plate having an arbitrary external frame shape and an arbitrary surface shape without performing the external frame processing on the cover glass plate and the post-processing on the surface of the cover glass plate.

### BRIEF DESCRIPTION OF DRAWINGS

FIGS. 1A to 1G A manufacturing process diagram showing a first embodiment of a method of manufacturing a cover glass plate;

FIGS. 2A to 2C A cross-sectional view showing specific examples of a preform;

FIGS. 3A to 3G A manufacturing process diagram showing a second embodiment of the method of manufacturing the cover glass plate;

FIGS. 4A to 4G A manufacturing process diagram showing a third embodiment of the method of manufacturing the cover glass plate;

FIGS. 5A and 5B A bottom view of specific examples of the preform; and

FIGS. 6A to 6G A manufacturing process diagram showing a fourth embodiment of the method of manufacturing the cover glass plate.

### BEST MODE FOR CARRYING OUT THE INVENTION

A method of manufacturing a cover glass plate according to the present invention will be described below with reference to accompanying drawings. The same parts as each other and the corresponding parts in embodiments, specific examples and the like are identified with the same symbols, and their description will not be repeated as necessary.

### First Embodiment

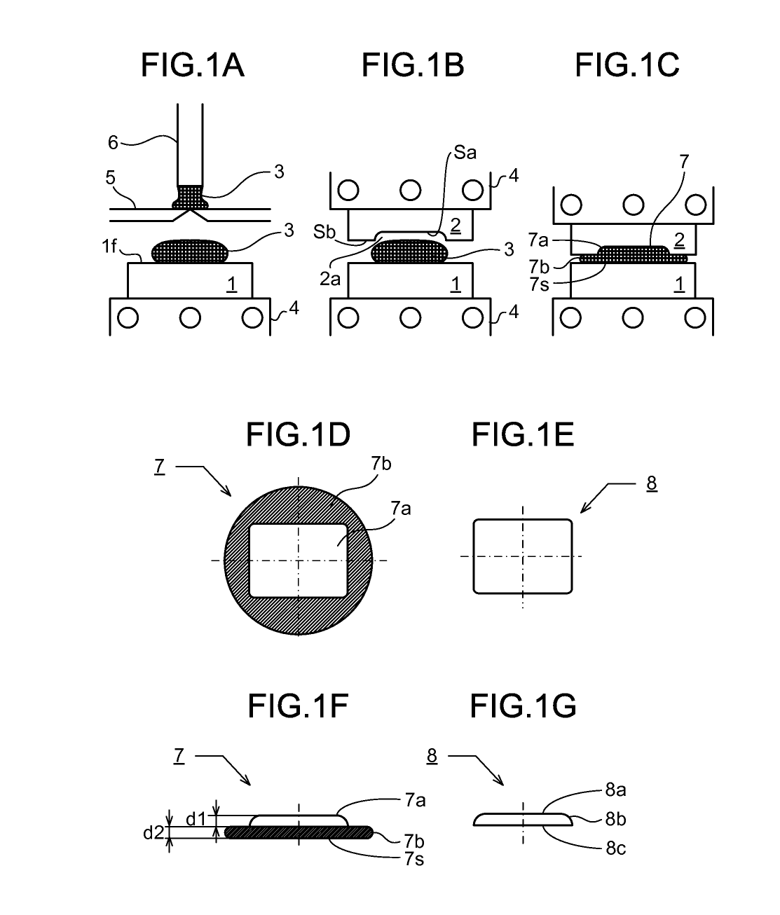

FIGS. 1A to 1G show a first embodiment of the method of manufacturing the cover glass plate. This manufacturing method includes a molding step shown in the cross-sectional views of FIGS. 1A to 1C and a processing step shown in the plan views of FIGS. 1D and 1E and the cross-sectional views of FIGS. 1F and 1G. In the molding step including a drop step (A), a movement step (B) and a press step (C), a preform (plate glass blank) 7 is formed by a direct press method, and in the processing step (D) to (G), a cover glass plate 8 is formed as a completed product. This cover glass plate 8 is used for covering, for example, the image display surface of a digital device (such as a mobile telephone, a smartphone or a mobile computer) having an image display function.

In the drop step (A), a constant amount of molten glass 3 is first dropped onto the flat surface portion if of a lower mold 1. Specifically, the molten glass 3 obtained by being melted in a melting furnace is made to flow out from a platinum nozzle 6, and is cut by a blade 5, and thus the constant amount of molten glass 3 is dropped onto the flat surface portion if of the lower mold 1. The lower mold 1 is heated by a heater 4 such that the molten glass 3 is prevented from being rapidly cooled by the lower mold 1. Hence, the molten glass 3 on the flat surface portion 1f is maintained and controlled in a state where a predetermined viscosity is kept.

In the subsequent movement step (B), the lower mold 1 is moved to a predetermined position below an upper mold 2. As in the lower mold 1, the upper mold 2 is heated by the heater 4 such that the molten glass 3 is prevented from being rapidly cooled by the upper mold 2. Hence, even if the molten glass 3 on the flat surface portion 1f is brought into contact with the upper mold 2, the molten glass 3 is maintained and controlled in a state where the predetermined viscosity is kept.

After the lower mold 1 is placed on standby for a predetermined time in the movement step (B), the process is moved to the press step (C). In the press step (C), the upper mold 2 is lowered to press the molten glass 3 on the flat surface portion if of the lower mold 1, thus a concave portion 2a of the upper mold 2 for molding is filled with the molten glass 3, furthermore the molten glass 3 overlaps the concave portion 2a to an area between the upper mold 2 and the lower mold 1 and the preform 7 having an overlap portion 7b is formed. As described above, the molten glass 3 is molded while overlapping the concave portion 2a, and thus it is possible to transfer the molding surface to the preform 7 to reach the outermost circumference of the external surface Sb (FIG. 1B) of the upper mold 2.

After the preform 7 obtained in the press step (C) is released from and taken out of the mold, the process is moved to the processing step (D) to (G). As shown in FIGS. 1D and 1F, the preform 7 is formed with a molded main body 7a and the overlap portion 7b (shaded area). When in the processing step, at least one of surface grinding and surface polishing is performed, and thus all the overlap portion 7b, which is an unnecessary portion, is removed from the preform 7 (that is, is removed up to the external frame circumferential surface of the molded main body 7a), only the molded main body 7a is left. In other words, as shown in FIGS. 1E and 1G, the cover glass plate 8 is formed as the completed product.

The surface grinding and the surface polishing for the overlap portion 7b are performed on a contact surface 7s with the flat surface portion 1f; at that time, the surface grinding is roughly and collectively performed with a polishing pad on a plurality of preforms 7, and then the surface polishing is more finely performed. It is possible to easily switch from the surface grinding to the surface polishing by changing a polishing liquid used for the contact surface 7s with the flat surface portion 1f. When it is not necessary to form the lower surface 8c of the cover glass plate 8 as a mirror surface, a coating is formed on the lower surface 8c, and thus a desired degree of smoothness may be obtained.

Since the external frame shape of the cover glass plate 8 is determined by the concave portion 2a of the upper mold 2, when all the overlap portion 7b is removed from the preform 7 by the surface grinding or the surface polishing in the processing step, it is not necessary to perform external frame processing (for example, external frame processing on the four surfaces corresponding to the rectangle of the image display surface) on the cover glass plate 8. Moreover, since the surface shape of the cover glass plate 8 is also determined by the concave portion 2a of the upper mold 2, it is not necessary to perform post-processing on the surface of the cover glass plate. Hence, in the configuration of the present embodiment, it is possible to easily manufacture the thin cover glass plate 8 having an arbitrary external frame shape and an arbitrary surface shape without performing the external frame processing on the cover glass plate 8 and the post-processing on the surface of the cover glass plate.

Since it is possible to highly accurately adjust a positional relationship between the flat surface portion 1f of the lower mold 1 and the concave portion 2a of the upper mold 2 for molding, the surface grinding or the surface polishing for the overlap portion 7b in the processing step is performed on the surface 7s (FIGS. 1C and 1F) in contact with the flat surface portion if of the lower mold 1 in the press step, and thus it is possible to highly accurately perform the surface grinding or the surface polishing in the processing step. Hence, in the configuration of the present embodiment, it is possible to easily remove only all the overlap portion 7b from the preform 7.

When all the overlap portion 7b is removed from the preform 7, the portion (that is, the molded main body 7a) formed with only the molten glass 3 with which the concave portion 2a of the upper mold 2 for molding is filled is left, and it is the completed product that serves as the cover glass plate 8. Although the lower surface 8c of the cover glass plate 8 is formed by the surface grinding or the surface polishing (FIG. 1G), since the other surfaces 8a and 8b are formed by the concave portion 2a of the upper mold 2, it is possible to reflect the high accuracy of the concave portion 2a on the surface accuracy of the upper surface 8a and the side surface 8b of the cover glass plate 8. For example, it is possible to perform molding such that the boundary between the upper surface 8a and the side surface 8b is a smooth curved surface. Hence, in the configuration of the present embodiment, it is possible to control and enhance the accuracy of the surfaces 8a and 8b other than the lower surface 8c of the cover glass plate 8. This configuration is particularly effective for the molding of glass that is difficult to control and that has a high viscosity.

The shape of the upper surface 8a of the cover glass plate 8 is determined by the shape of the concave portion 2a filled with the molten glass 3. Hence, as shown in FIG. 1B, the surface shape of part (or the whole) of the concave portion 2a is curved, and thus it is possible to curve the surface shape of part (or the whole) of the upper surface 8a of the cover glass plate 8. Thus, in the configuration of the present embodiment, it is possible to easily satisfy needs for changing, in specifications, the surface of the cover glass plate 8 from a flat surface to a curved surface.

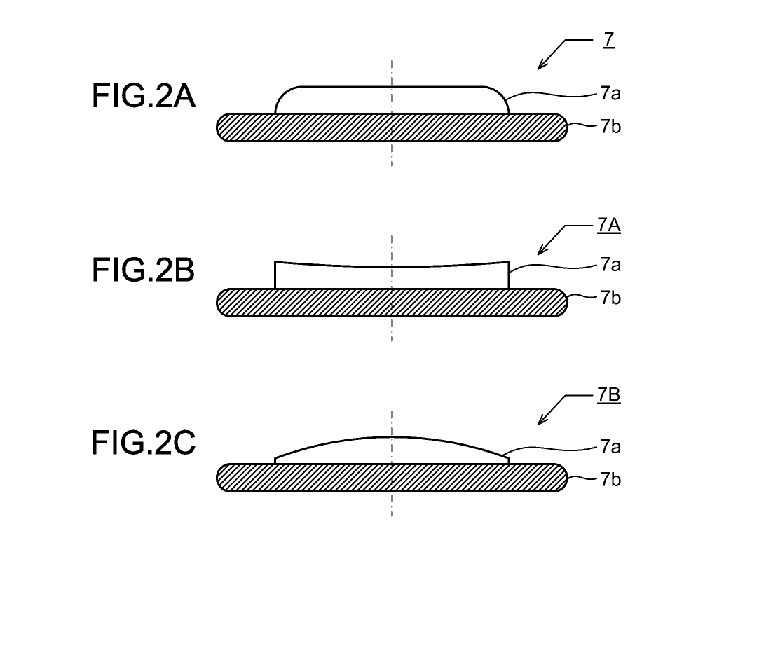

FIGS. 2A to 2C show specific examples of the preform 7. FIG. 2A shows the preform 7 obtained in the molding step of FIGS. 1A to 1G. In other words, this preform 7 has a flat surface in the molded main body 7a. FIG. 2B shows a preform 7A in which the molded main body 7a has a concave surface; FIG. 2C shows a preform 7B in which the molded main body 7a has a convex surface. As will be understood from these specific examples, when various shapes of the concave portion 2a of the upper mold 2 are introduced, it is possible to produce the cover glass plates 8 of various shapes (arbitrary curved surfaces; a convex surface, a concave surface; a spherical surface, a cylindrical surface and the like). When as shown in FIG. 2C, the molded main body 7a has a convex surface, since the thickness of the side surface is excessively small, it is difficult to perform the external frame processing on the four surfaces corresponding to the rectangle of the image display surface. However, in the configuration of the present embodiment, even if the thickness of the side surface is excessively small, it is possible to easily remove all the overlap portion 7b from the preform 7 by the surface grinding or the surface polishing.

Although the upper surface 8a and the side surface 8b are formed to be mirror surfaces, and this reduces the releasability of the upper mold 2, the releasability of the upper mold 2 is improved by the presence of the overlap portion 7b. Hence, it is possible to stably keep the state where the preform 7 is placed on the lower mold 1 after the press step (C), with the result that it is easy to pick up the preform 7 from the lower mold 1. When in the press step (C), the external surface Sb (FIG. 1B) of the upper mold 2 in contact with the overlap portion 7b is roughened as compared with the internal surface Sa (FIG. 1B) of the concave portion 2a, since a rough surface portion is separated by a glass contraction action after the completion of the molding, and thus the release of the contact surface of the preform is facilitated, it is possible to effectively enhance the releasability of the preform 7.

In the present embodiment, it is assumed that the size of the cover glass plate 8 is height×width×thickness (d1)=80×100×0.7 (mm) The thickness d1 (FIG. 1F) of the cover glass plate 8 is preferably 0.2 to 1.5 mm, and is more preferably 0.7 to 1.0 mm. In terms of balance with the thickness d1 of the molded main body 7a, the thickness d2 (FIG. 1F) of the overlap portion 7b is preferably about 0.5 to 1.0 mm. When the overlap portion 7b is excessively thin, it is easily broken, and the accuracy of the shape of the side surface 8b is reduced. On the other hand, when the overlap portion 7b is excessively thick, it takes more time to perform the surface grinding and the surface polishing. As the volume is increased, the amount of shrinkage is increased, and thus the molding surface is likely to be degraded. When the overlap portion 7b is prevented from being produced, a space is produced within the concave surface of the upper mold, and thus high accurate molding is unlikely to be performed, with the result that it is difficult to control the volume so as to perform stable molding.

### Second Embodiment

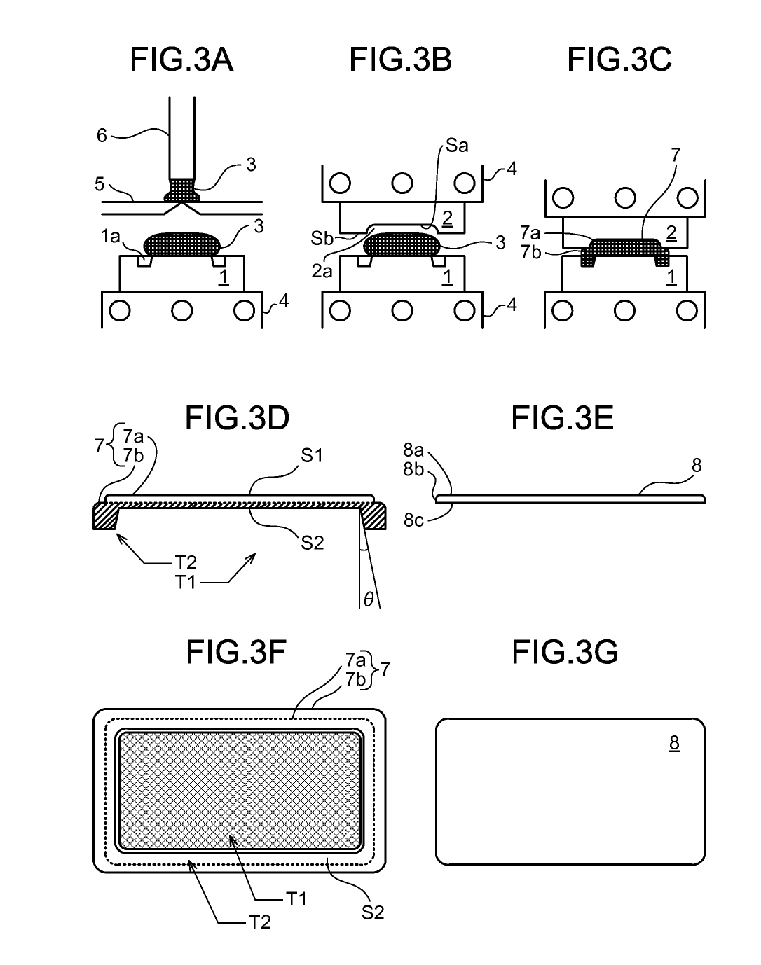

FIGS. 3A to 3G show a second embodiment of the method of manufacturing the cover glass plate. This manufacturing method includes a molding step shown in the cross-sectional views of FIGS. 3A to 3C and a processing step shown in the cross-sectional views of FIGS. 3D and 3E and the bottom views of FIGS. 3F and 3G. In the molding step including a drop step (A), a movement step (B) and a press step (C), a preform 7 is formed by the direct press method, and in the processing step (D) to (G), a cover glass plate 8 is formed as a completed product. This cover glass plate 8 is used for covering, for example, the image display surface of a digital device (such as a mobile telephone, a smartphone or a mobile computer) having an image display function.

In the drop step (A), a constant amount of molten glass 3 is first dropped onto a lower mold 1 having a concave portion 1a. Specifically, the molten glass 3 obtained by being melted in a melting furnace is made to flow out from a platinum nozzle 6, and is cut by a blade 5, and thus the constant amount of molten glass 3 is dropped onto the lower mold 1. The lower mold 1 is heated by a heater 4 such that the molten glass 3 is prevented from being rapidly cooled by the lower mold 1. Hence, the molten glass 3 on the lower mold 1 is maintained and controlled in a state where a predetermined viscosity is kept.

In the subsequent movement step (B), the lower mold 1 is moved to a predetermined position below an upper mold 2. As in the lower mold 1, the upper mold 2 is heated by the heater 4 such that the molten glass 3 is prevented from being rapidly cooled by the upper mold 2. Hence, even if the molten glass 3 on the lower mold 1 is brought into contact with the upper mold 2, the molten glass 3 is maintained and controlled in a state where the predetermined viscosity is kept.

After the lower mold 1 is placed on standby for a predetermined time in the movement step (B), the process is moved to the press step (C). In the press step (C), the upper mold 2 having a concave portion 2a for molding is lowered to press the molten glass 3 on the lower mold 1, thus the concave portion 2a of the upper mold 2 for molding is filled with the molten glass 3, furthermore the molten glass 3 overlaps the concave portion 2a to an area between the upper mold 2 and the lower mold 1 and into the concave portion 1a and the preform 7 having the overlap portion 7b is formed. As described above, the molten glass 3 is molded while overlapping the concave portion 2a to the area between the upper mold 2 and the lower mold, and thus it is possible to transfer the molding surface to the preform 7 to reach the external surface Sb (FIG. 3B) of the upper mold 2.

After the preform 7 obtained in the press step (C) is released from and taken out of the mold, the process is moved to the processing step (D) to (G). As shown in FIGS. 3D and 3F, the preform 7 is formed with a molded main body 7a and the overlap portion 7b (shaded area in FIG. 3D). A first surface S1 (molding surface) is formed with the molten glass 3 with which the concave portion 2a of the upper mold 2 for molding is filled, and a second surface S2 (processed surface) having a rectangular concave portion T1 and a convex portion T2 in the shape of the letter U surrounding its vicinity is formed with the molten glass 3 with which the concave portion 1a of the lower mold 1 is filled. When in the processing step, at least one of surface grinding and surface polishing is performed, and thus all the overlap portion 7b, which is an unnecessary portion, is removed from the preform 7 (that is, is removed up to the external frame circumferential surface of the molded main body 7a), only the molded main body 7a is left. In other words, as shown in FIGS. 3E and 3G, the cover glass plate 8 is formed as the completed product.

The surface grinding and the surface polishing for the overlap portion 7b are performed on the second surface S2; at that time, the surface grinding is roughly and collectively performed with a polishing pad or a polishing stone on a plurality of preforms 7, and then the surface polishing is more finely performed with polishing pad. It is possible to easily switch from the surface grinding to the surface polishing by changing a polishing liquid used for the second surface S2. When it is not necessary to form the lower surface 8c of the cover glass plate 8 as a mirror surface, a coating is formed on the lower surface 8c, and thus a desired degree of smoothness may be obtained. Examples of the coating include an anti-scattering film and a resin coat.

Since the external frame shape of the cover glass plate 8 is determined by the concave portion 2a of the upper mold 2, when all the overlap portion 7b is removed from the preform 7 by the surface grinding or the surface polishing in the processing step, it is not necessary to perform external frame processing (for example, external frame processing on the four surfaces corresponding to the rectangle of the image display surface) on the cover glass plate 8. Moreover, since the surface shape of the cover glass plate 8 is also determined by the concave portion 2a of the upper mold 2, it is not necessary to perform post-processing on the surface of the cover glass plate. Hence, in the configuration of the present embodiment, it is possible to easily manufacture the thin cover glass plate 8 having an arbitrary external frame shape and an arbitrary surface shape without performing the external frame processing on the cover glass plate 8 and the post-processing on the surface of the cover glass plate.

Since it is possible to highly accurately adjust a positional relationship between the concave portion 1a of the lower mold 1 and the concave portion 2a of the upper mold 2 for molding, the surface grinding or the surface polishing for the overlap portion 7b in the processing step is performed on the second surface S2 (FIGS. 3D and 3F), and thus it is possible to highly accurately perform the surface grinding or the surface polishing in the processing step. Hence, in the configuration of the present embodiment, it is possible to easily remove only all the overlap portion 7b from the preform 7.

When all the overlap portion 7b is removed from the preform 7, the portion (that is, the molded main body 7a) formed with only the molten glass 3 with which the concave portion 2a of the upper mold 2 for molding is filled is left, and it is the completed product that serves as the cover glass plate 8. Although the lower surface 8c of the cover glass plate 8 is formed by the surface grinding or the surface polishing (FIG. 3E), since the other surfaces 8a and 8b are formed by the concave portion 2a of the upper mold 2, it is possible to reflect the high accuracy of the concave portion 2a on the surface accuracy of the upper surface 8a and the side surface 8b of the cover glass plate 8. For example, it is possible to perform molding such that the boundary between the upper surface 8a and the side surface 8b is a smooth curved surface. Hence, in the configuration of the present embodiment, it is possible to control and enhance the accuracy of the surfaces 8a and 8b other than the lower surface 8c of the cover glass plate 8. This configuration is particularly effective for the molding of glass that is difficult to control and that has a high viscosity.

The shape of the upper surface 8a of the cover glass plate 8 is determined by the shape of the concave portion 2a filled with the molten glass 3. Hence, as shown in FIG. 3B, the surface shape of part (or the whole) of the concave portion 2a is curved, and thus it is possible to curve the surface shape of part (or the whole) of the upper surface 8a of the cover glass plate 8. Thus, in the configuration of the present embodiment, it is possible to easily satisfy needs for changing, in specifications, the surface of the cover glass plate 8 from a flat surface to a curved surface.

The preform 7 is not limited to the preform 7 in which the molded main body 7a has a flat surface, and may be a preform 7 in which the molded main body 7a has a concave surface or a convex surface. When various shapes of the concave portion 2a of the upper mold 2 are introduced, it is possible to produce the cover glass plates 8 of various shapes (arbitrary curved surfaces; a convex surface, a concave surface; a spherical surface, a cylindrical surface and the like). When the molded main body 7a has a convex surface, since the thickness of the side surface is excessively small, it is difficult to perform the external frame processing on the four surfaces corresponding to the rectangle of the image display surface. However, in the configuration of the present embodiment, even if the thickness of the side surface is excessively small, it is possible to easily remove all the overlap portion 7b from the preform 7 by the surface grinding or the surface polishing.

Although the upper surface 8a and the side surface 8b are formed to be mirror surfaces, and this reduces the releasability of the upper mold 2, the releasability of the upper mold 2 is improved by the presence of the overlap portion 7b. Hence, it is possible to stably keep the state where the preform 7 is placed on the lower mold 1 after the press step (C), with the result that it is easy to pick up the preform 7 from the lower mold 1. When in the press step (C), the external surface Sb (FIG. 3B) of the upper mold 2 in contact with the overlap portion 7b is roughened as compared with the internal surface Sa (FIG. 3B) of the concave portion 2a, since a rough surface portion is separated by a glass contraction action after the completion of the molding, and thus the release of the contact surface of the preform is facilitated, it is possible to effectively enhance the releasability of the preform 7.

The surface grinding or the surface polishing is performed on the second surface S2, which is the back surface of the first surface S1 formed by the upper mold 2, and thus it is possible to obtain the surface shape of high accuracy both in the first surface S1 and in the second surface S2. However, in order to acquire the accuracy of the first surface S1, it is necessary to acquire as large a molding thickness as possible; as the molding thickness is increased, the processing load of the grinding or the polishing is increased. As in the present embodiment, the second surface S2 has the concave portion T1 and the convex portion T2, and thus the processing load of the grinding or the polishing is reduced, and moreover, with the recess and projection thereof, it is possible to obtain the dressing effect of a polishing stone (the effect of removing the clogging of the polishing stone). Hence, since with the preform 7 (FIGS. 3D and 3F) having the concave portion T1 and the convex portion T2 in the second surface S2, it is possible to easily flatten the second surface S2 in a predetermined position by the surface grinding or the surface polishing, it is possible to reduce the processing time and the processing cost, with the result that it is possible to easily manufacture the cover glass plate 8 having the surface shape of high accuracy both in the first surface S1 and in the second surface S2.

When as in the present embodiment, the convex portion T2 is arranged in the outermost circumference of the second surface S2, since the center portion is relatively reduced in thickness to decrease the amount of contraction of the glass, the solidification of the glass in its peripheral portion is alleviated and the warpage of the preform 7 is reduced, it is possible to easily enhance the accuracy of transfer of the first surface S1. If the area of the convex portion T2 on the second surface S2 is one-fourth or more the entire surface, its effect is further increased.

Since the mold is lower in temperature than the dropped molten glass, the dropped glass starts to be solidified. Since the peripheral portion of the glass is easily solidified, if the convex portion T2 is not present in the outermost circumference, when pressing is performed with the upper mold, the accuracy of the transfer is likely to be degraded because the glass is prevented from being spread over the peripheral portion. In the pressed and molded product, the center portion is also higher in glass temperature than the peripheral portion. Since the center portion is higher in the rate of shrinkage of the glass than the peripheral portion due to the high temperature, the amount of shrinkage in the center portion of the glass is increased after the completion of the pressing (after the completion of the pushing in of the upper mold, and thus the insufficient amount of transfer of and the warpage of the mold occur in the preform 7. In the present embodiment, the convex portion T2 is provided in the outermost circumference to increase the thickness of the outermost circumference, and the heat capacity is increased, and thus an outer circumferential portion is difficult to cool, and the glass is easily spread over the peripheral portion at the time of the pressing. The center portion is relatively reduced in thickness than the outer circumferential portion, and thus it is possible to balance the center portion having a high rate of shrinkage and the peripheral portion having a low rate of shrinkage, with the result that a uniform amount of shrinkage is achieved over the entire preform 7 and thus it is possible to enhance the function of the transfer of the molding.

If the area of the convex portion T2 on the second surface S2 is one-half or less the area of the concave portion T1, it is possible to effectively achieve both the surface accuracy and the processibility. When the side surface of the concave portion T1 has a draft taper shape of 3° or more with respect to the normal to the bottom surface (a cross-hatched portion in FIG. 3F) of the concave portion T1 (angle θ in FIG. 3D≧3°), it is possible to easily enhance the releasability.

### Third Embodiment

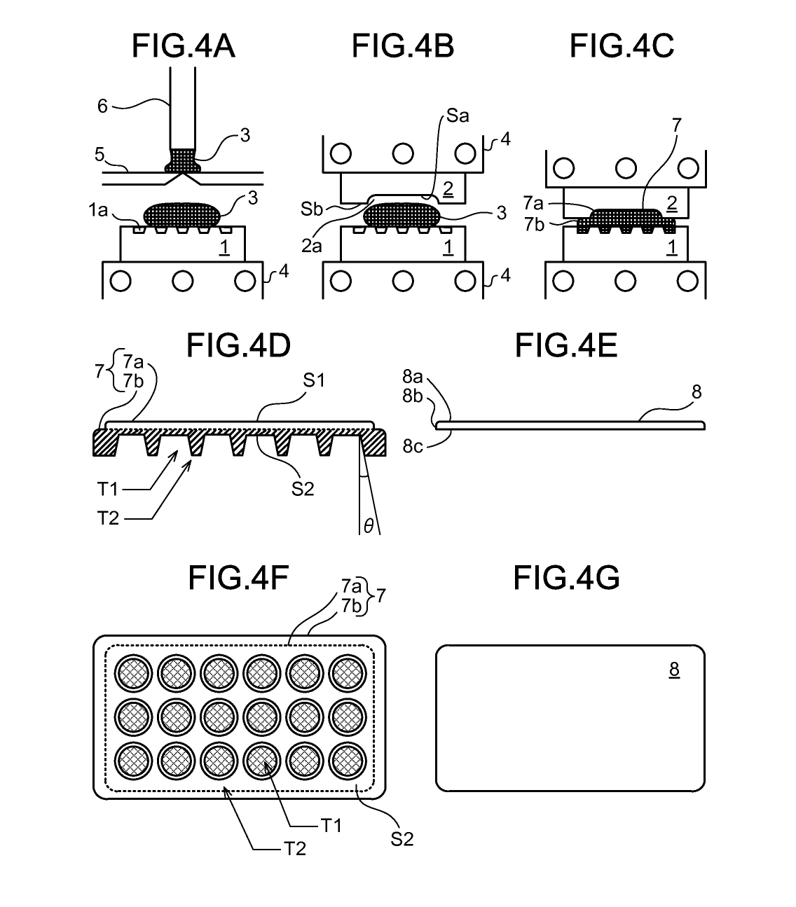

FIGS. 4A to 4G show a third embodiment of the method of manufacturing the cover glass plate. This manufacturing method includes a molding step shown in the cross-sectional views of FIGS. 4A to 4C and a processing step shown in the cross-sectional views of FIGS. 4D and 4E and the bottom views of FIGS. 4F and 4G. In the molding step including a drop step (A), a movement step (B) and a press step (C), a preform 7 is formed by the direct press method, and in the processing step (D) to (G), a cover glass plate 8 is formed as a completed product. This cover glass plate 8 is used for covering, for example, the image display surface of a digital device (such as a mobile telephone, a smartphone or a mobile computer) having an image display function.

In the drop step (A), a constant amount of molten glass 3 is first dropped onto a lower mold 1 having a concave portion 1a. Specifically, the molten glass 3 obtained by being melted in a melting furnace is made to flow out from a platinum nozzle 6, and is cut by a blade 5, and thus the constant amount of molten glass 3 is dropped onto the lower mold 1. The lower mold 1 is heated by a heater 4 such that the molten glass 3 is prevented from being rapidly cooled by the lower mold 1. Hence, the molten glass 3 on the lower mold 1 is maintained and controlled in a state where a predetermined viscosity is kept.

In the subsequent movement step (B), the lower mold 1 is moved to a predetermined position below an upper mold 2. As in the lower mold 1, the upper mold 2 is heated by the heater 4 such that the molten glass 3 is prevented from being rapidly cooled by the upper mold 2. Hence, even if the molten glass 3 on the lower mold 1 is brought into contact with the upper mold 2, the molten glass 3 is maintained and controlled in a state where the predetermined viscosity is kept.

After the lower mold 1 is placed on standby for a predetermined time in the movement step (B), the process is moved to the press step (C). In the press step (C), the upper mold 2 having a concave portion 2a for molding is lowered to press the molten glass 3 on the lower mold 1, thus the concave portion 2a of the upper mold 2 for molding is filled with the molten glass 3, furthermore the molten glass 3 overlaps the concave portion 2a to an area between the upper mold 2 and the lower mold 1 and into the concave portion 1a and the preform 7 having the overlap portion 7b is formed. As described above, the molten glass 3 is molded while overlapping the concave portion 2a to the area between the upper mold 2 and the lower mold 1, and thus it is possible to transfer the molding surface to the preform 7 to reach the external surface Sb (FIG. 4B) of the upper mold 2.

After the preform 7 obtained in the press step (C) is released from and taken out of the mold, the process is moved to the processing step (D) to (G). As shown in FIGS. 4D and 4F, the preform 7 is formed with a molded main body 7a and the overlap portion 7b (shaded area in FIG. 4D). A first surface S1 (molding surface) is formed with the molten glass 3 with which the concave portion 2a of the upper mold 2 for molding is filled, and a second surface S2 (processed surface) having a plurality of circular concave portions T1 and a rectangular convex portion T2 formed so as to protrude relatively thereto is formed with the molten glass 3 with which the concave portion 1a of the lower mold 1 is filled. When in the processing step, at least one of surface grinding and surface polishing is performed, and thus all the overlap portion 7b, which is an unnecessary portion, is removed from the preform 7 (that is, is removed up to the external frame circumferential surface of the molded main body 7a), only the molded main body 7a is left. In other words, as shown in FIGS. 4E and 4G, the cover glass plate 8 is formed as the completed product.

The surface grinding and the surface polishing for the overlap portion 7b are performed on the second surface S2; at that time, the surface grinding is roughly and collectively performed with a polishing pad or a polishing stone on a plurality of preforms 7, and then the surface polishing is more finely performed with the polishing pad. It is possible to easily switch from the surface grinding to the surface polishing by changing a polishing liquid used for the second surface S2. When it is not necessary to form the lower surface 8c of the cover glass plate 8 as a mirror surface, a coating is formed on the lower surface 8c, and thus a desired degree of smoothness may be obtained.

Since the external frame shape of the cover glass plate 8 is determined by the concave portion 2a of the upper mold 2, when all the overlap portion 7b is removed from the preform 7 by the surface grinding or the surface polishing in the processing step, it is not necessary to perform external frame processing (for example, external frame processing on the four surfaces corresponding to the rectangle of the image display surface) on the cover glass plate 8. Moreover, since the surface shape of the cover glass plate 8 is also determined by the concave portion 2a of the upper mold 2, it is not necessary to perform post-processing on the surface of the cover glass plate. Hence, in the configuration of the present embodiment, it is possible to easily manufacture the thin cover glass plate 8 having an arbitrary external frame shape and an arbitrary surface shape without performing the external frame processing on the cover glass plate 8 and the post-processing on the surface of the cover glass plate.

Since it is possible to highly accurately adjust a positional relationship between the concave portion 1a of the lower mold 1 and the concave portion 2a of the upper mold 2 for molding, the surface grinding or the surface polishing for the overlap portion 7b in the processing step is performed on the second surface S2 (FIGS. 4D and 4F) in the press step, and thus it is possible to highly accurately perform the surface grinding or the surface polishing in the processing step. Hence, in the configuration of the present embodiment, it is possible to easily remove only all the overlap portion 7b from the preform 7.

When all the overlap portion 7b is removed from the preform 7, the portion (that is, the molded main body 7a) formed with only the molten glass 3 with which the concave portion 2a of the upper mold 2 for molding is filled is left, and it is the completed product that serves as the cover glass plate 8. Although the lower surface 8c of the cover glass plate 8 is formed by the surface grinding or the surface polishing (FIG. 4E), since the other surfaces 8a and 8b are formed by the concave portion 2a of the upper mold 2, it is possible to reflect the high accuracy of the concave portion 2a on the surface accuracy of the upper surface 8a and the side surface 8b of the cover glass plate 8. For example, it is possible to perform molding such that the boundary between the upper surface 8a and the side surface 8b is a smooth curved surface. Hence, in the configuration of the present embodiment, it is possible to control and enhance the accuracy of the surfaces 8a and 8b other than the lower surface 8c of the cover glass plate 8. This configuration is particularly effective for the molding of glass that is difficult to control and that has a high viscosity.

The shape of the upper surface 8a of the cover glass plate 8 is determined by the shape of the concave portion 2a filled with the molten glass 3. Hence, as shown in FIG. 4B, the surface shape of part (or the whole) of the concave portion 2a is curved, and thus it is possible to curve the surface shape of part (or the whole) of the upper surface 8a of the cover glass plate 8. Thus, in the configuration of the present embodiment, it is possible to easily satisfy needs for changing, in specifications, the surface of the cover glass plate 8 from a flat surface to a curved surface.

The preform 7 is not limited to the preform 7 in which the molded main body 7a has a flat surface, and may be a preform 7 in which the molded main body 7a has a concave surface or a convex surface. When various shapes of the concave portion 2a of the upper mold 2 are introduced, it is possible to produce the cover glass plates 8 of various shapes (arbitrary curved surfaces; a convex surface, a concave surface; a spherical surface, a cylindrical surface and the like). When the molded main body 7a has a convex surface, since the thickness of the side surface is excessively small, it is difficult to perform the external frame processing on the four surfaces corresponding to the rectangle of the image display surface. However, in the configuration of the present embodiment, even if the thickness of the side surface is excessively small, it is possible to easily remove all the overlap portion 7b from the preform 7 by the surface grinding or the surface polishing.

Although the upper surface 8a and the side surface 8b are formed to be mirror surfaces, and this reduces the releasability of the upper mold 2, the releasability of the upper mold 2 is improved by the presence of the overlap portion 7b. Hence, it is possible to stably keep the state where the preform 7 is placed on the lower mold 1 after the press step (C), with the result that it is easy to pick up the preform 7 from the lower mold 1. When in the press step (C), the external surface Sb (FIG. 4B) of the upper mold 2 in contact with the overlap portion 7b is roughened as compared with the internal surface Sa (FIG. 4B) of the concave portion 2a, since a rough surface portion is separated by a glass contraction action after the completion of the molding, and thus the release of the contact surface of the preform is facilitated, it is possible to effectively enhance the releasability of the preform 7.

The surface grinding or the surface polishing is performed on the second surface S2, which is the back surface of the first surface S1 formed by the upper mold 2, and thus it is possible to obtain the surface shape of high accuracy both in the first surface S1 and in the second surface S2. However, in order to acquire the accuracy of the first surface S1, it is necessary to acquire as large a molding thickness as possible; as the molding thickness is increased, the processing load of the grinding or the polishing is increased. As in the present embodiment, the second surface S2 has the concave portion T1 and the convex portion T2, and thus the processing load of the grinding or the polishing is reduced, and moreover, with the recess and projection thereof, it is possible to obtain the dressing effect of a polishing stone (the effect of removing the clogging of the polishing stone). Hence, since with the preform 7 (FIGS. 4D and 4F) having the concave portion T1 and the convex portion T2 in the second surface S2, it is possible to easily flatten the second surface S2 in a predetermined position by the surface grinding or the surface polishing, it is possible to reduce the processing time and the processing cost, with the result that it is possible to easily manufacture the cover glass plate 8 having the surface shape of high accuracy both in the first surface S1 and in the second surface S2.

When as in the present embodiment, the convex portion T2 is arranged in the outermost circumference of the second surface S2, since the center portion is relatively reduced in thickness to decrease the amount of contraction of the glass, the solidification of the glass in its peripheral portion is alleviated and the warpage of the preform 7 is reduced, it is possible to easily enhance the accuracy of transfer of the first surface S1. If the area of the convex portion T2 on the second surface S2 is one-fourth or more the entire surface, its effect is further increased. Although the degree of the warpage differs depending on the plate thickness and the size of the preform 7, as in the present embodiment, a plurality of (or one depending on the case of) circular concave portions T1 are arranged to perform reinforcing, and thus it is possible to effectively reduce the warpage of the preform 7.

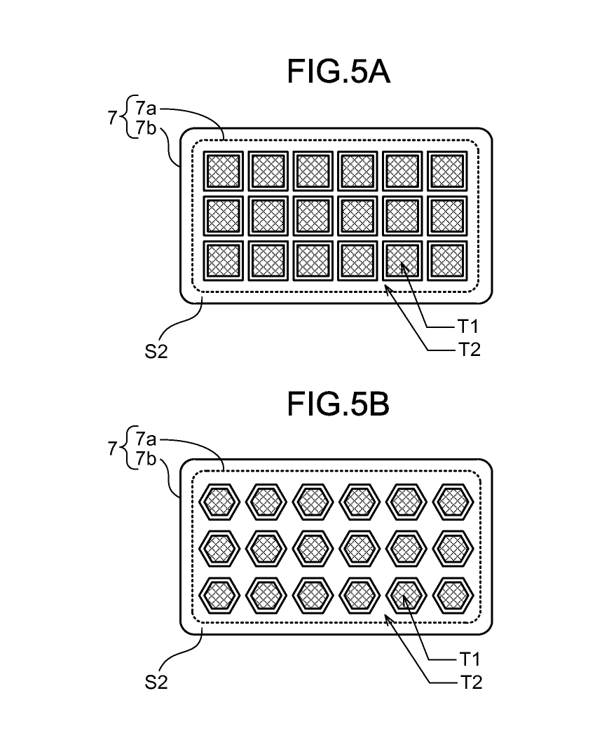

The shape of the concave portion T1 is not limited to the circular shape but may be a shape, such as a square shape, a honeycomb shape or a mesh shape, that can be easily processed. FIGS. 5A and 5B show other specific examples of the preform 7. In the preform 7 shown in FIG. 5A, the shape of the concave portion T1 of the second surface S2 is a square shape; in the preform 7 shown in FIG. 5B, the shape of the concave portion T1 of the second surface S2 is a honeycomb shape. With any shape of the concave portion T1, it is effective for reducing the warpage of the preform 7.

If the area of the convex portion T2 on the second surface S2 is one-half or less the area of the concave portion T1, it is possible to effectively achieve both the surface accuracy and the processibility. When the side surface of the concave portion T1 has a draft taper shape of 3° or more with respect to the normal to the bottom surface (a cross-hatched portion in FIG. 4F) of the concave portion T1 (angle θ in FIG. 4D≧3°), it is possible to easily enhance the releasability.

### Fourth Embodiment

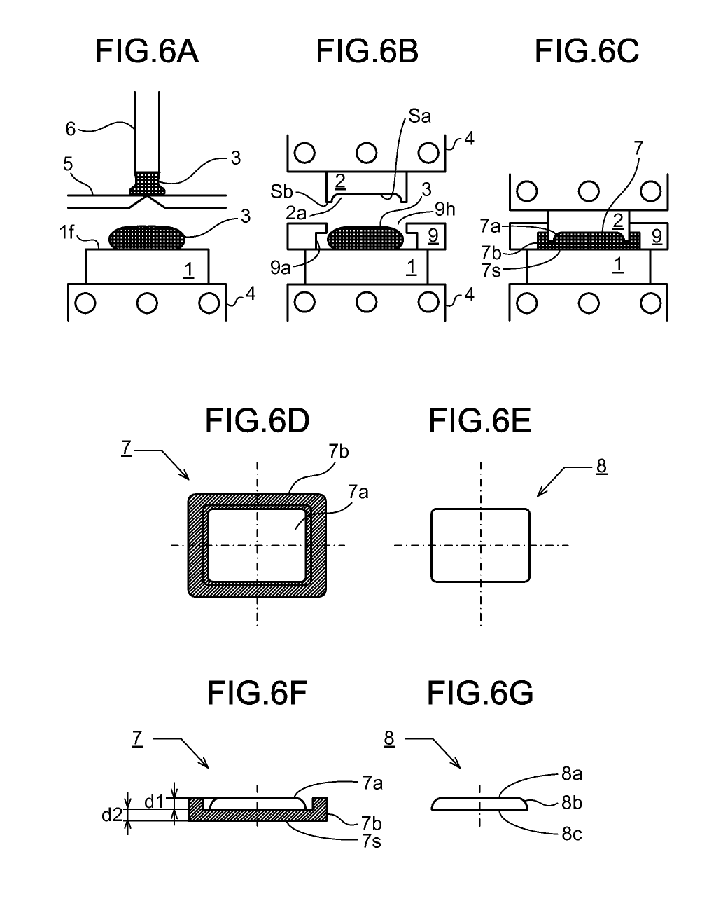

FIGS. 6A to 6G show a fourth embodiment of the method of manufacturing the cover glass plate. This manufacturing method includes a molding step shown in the cross-sectional views of FIGS. 6A to 6C and a processing step shown in the plan views of FIGS. 6D and 6E and the cross-sectional views of FIGS. 6F and 6G. In the molding step including a drop step (A), a movement step (B) and a press step (C), a preform 7 is formed by the direct press method, and in the processing step (D) to (G), a cover glass plate 8 is formed as a completed product. This cover glass plate 8 is used for covering, for example, the image display surface of a digital device (such as a mobile telephone, a smartphone or a mobile computer) having an image display function.

In the drop step (A), a constant amount of molten glass 3 is first dropped onto a flat surface portion if of the lower mold 1. Specifically, the molten glass 3 obtained by being melted in a melting furnace is made to flow out from a platinum nozzle 6, and is cut by a blade 5, and thus the constant amount of molten glass 3 is dropped onto the flat surface portion 1f of the lower mold 1. The lower mold 1 is heated by a heater 4 such that the molten glass 3 is prevented from being rapidly cooled by the lower mold 1. Hence, the molten glass 3 on the flat surface portion 1f is maintained and controlled in a state where a predetermined viscosity is kept.

In the subsequent movement step (B), the lower mold 1 is moved to a predetermined position below an upper mold 2, and an external mold 9 is arranged between the upper mold 2 and the lower mold 1. Here, the external mold 9 is arranged on the lower mold 1 so as to surround the molten glass 3. In the upper portion of the external mold 9, a rectangular opening portion 9h is formed, and the upper mold 2 can be fitted into the opening portion 9h. As in the lower mold 1, the upper mold 2 is heated by the heater 4 such that the molten glass 3 is prevented from being rapidly cooled by the upper mold 2. Hence, even if the molten glass 3 on the flat surface portion if is brought into contact with the upper mold 2, the molten glass 3 is maintained and controlled in a state where the predetermined viscosity is kept.

After the lower mold 1 is placed on standby for a predetermined time in the movement step (B), the process is moved to the press step (C). In the press step (C), the upper mold 2 is lowered to press the molten glass 3 on the flat surface portion if of the lower mold 1, thus the concave portion 2a of the upper mold 2 for molding is filled with the molten glass 3, furthermore the molten glass 3 overlaps the concave portion 2a to an area between the upper mold 2 and the lower mold 1 and the preform 7 having the overlap portion 7b is formed. Here, the spread of the overlap portion 7b is restricted by the inner wall surface 9a (FIG. 6B) of the external mold 9, and the space within the mold is filled with the molten glass 3. As described above, the molten glass 3 is molded while overlapping the concave portion 2a, and thus it is possible to transfer the molding surface to the preform 7 to reach the outermost circumference of the external surface Sb (FIG. 6B) of the upper mold 2. Although here, in order for the concave portion 2a to be more reliably filled with the molten glass 3, the molten glass 3 is raised along the outer circumference of the upper mold 2, its restriction position is preferably set as necessary. For example, the molten glass 3 may be restricted such that the molten glass 3 is prevented from being raised beyond the position of the external surface Sb.

In general, it is difficult to make uniform the spread (overlap) of the molten glass 3 whose temperature distribution is non-uniform. Hence, it is difficult to stably fill the concave portion 2a with the molten glass 3. However, the flow of the molten glass 3 is restricted by the inner wall surface 9a of the external mold 9 as described above, and thus the non-uniform flow of the molten glass 3 is prevented by the external mold 9 and the molten glass 3 flows from the filled part to the non-filled part in the space within the mold, with the result that the concave portion 2a is filled with the molten glass 3 easily and reliably.

By restricting the spread of the overlap portion 7b with the external mold 9 as described above, it is possible to more enhance the moldability. In other words, since it is possible to reliably perform the transfer, it is possible to obtain the molding surface of a predetermined shape easily, reliably and stably. Moreover, since the displacement of the molten glass 3 is reduced, the temperature distribution is made uniform, and thus the surface accuracy is enhanced. Furthermore, since the space within the mold is constant, when the volume of the molten glass 3 dropped is made substantially constant, the thickness of the preform 7 is stabilized. The clearance between the molds is set at a predetermined size, and thus it is possible to easily discharge the air from the space within the mold while retaining the molten glass 3 in the space within the mold.

After the preform 7 obtained in the press step (C) is released from and taken out of the mold, the process is moved to the processing step (D) to (G). As shown in FIGS. 6D and 6F, the preform 7 is formed with a molded main body 7a and the overlap portion 7b (shaded area). When in the processing step, at least one of surface grinding and surface polishing is performed, and thus all the overlap portion 7b, which is an unnecessary portion, is removed from the preform 7 (that is, is removed up to the external frame circumferential surface of the molded main body 7a), only the molded main body 7a is left. In other words, as shown in FIGS. 6E and 6G, the cover glass plate 8 is formed as the completed product.

The surface grinding and the surface polishing for the overlap portion 7b are performed on the contact surface 7s with the flat surface portion 1f; at that time, the surface grinding is roughly and collectively performed with a polishing pad on a plurality of preforms 7, and then the surface polishing is more finely performed. It is possible to easily switch from the surface grinding to the surface polishing by changing a polishing liquid used for the contact surface 7s with the flat surface portion lf. When it is not necessary to form the lower surface 8c of the cover glass plate 8 as a mirror surface, a coating is formed on the lower surface 8c, and thus a desired degree of smoothness may be obtained.

Since the external frame shape of the cover glass plate 8 is determined by the concave portion 2a of the upper mold 2, when all the overlap portion 7b is removed from the preform 7 by the surface grinding or the surface polishing in the processing step, it is not necessary to perform external frame processing (for example, external frame processing on the four surfaces corresponding to the rectangle of the image display surface) on the cover glass plate 8. Moreover, since the surface shape of the cover glass plate 8 is also determined by the concave portion 2a of the upper mold 2, it is not necessary to perform post-processing on the surface of the cover glass plate. Hence, in the configuration of the present embodiment, it is possible to easily manufacture the thin cover glass plate 8 having an arbitrary external frame shape and an arbitrary surface shape without performing the external frame processing on the cover glass plate 8 and the post-processing on the surface of the cover glass plate.

Since it is possible to highly accurately adjust a positional relationship between the flat surface portion 1f of the lower mold 1 and the concave portion 2a of the upper mold 2 for molding, the surface grinding or the surface polishing for the overlap portion 7b in the processing step is performed on the contact surface 7s (FIGS. 6D and 6(F)) with the flat surface portion if of the lower mold 1 in the press step, and thus it is possible to highly accurately perform the surface grinding or the surface polishing in the processing step. Hence, in the configuration of the present embodiment, it is possible to easily remove only all the overlap portion 7b from the preform 7.

As the reference surface for the surface grinding and the surface polishing on the overlap portion 7b, the molding surface (the molding surface molded in the internal surface Sa or the external surface Sb) molded with the upper mold 2 is preferably used. For example, preferably, the molding flat surface of the molded main body 7a or the overlap portion 7b is used as the reference, a jig is adhered to the reference flat surface so that the jig is removable with respect to the reference flat surface, and the surface grinding and the surface polishing are performed. On the surface 7s (FIGS. 6C and 6F) formed on the flat surface portion 1f of the lower mold 1 in the press step, as in the second surface S2 shown in FIGS. 3A to 3G and 4A to 4G, the concave portion T1 and the convex portion T2 may be provided. The provision of the concave portion T1 and the convex portion T2 is effective for reducing the warpage of the preform 7 as described previously.

When all the overlap portion 7b is removed from the preform 7, the portion (that is, the molded main body 7a) formed with only the molten glass 3 with which the concave portion 2a of the upper mold 2 for molding is filled is left, and it is the completed product that serves as the cover glass plate 8. Although the lower surface 8c of the cover glass plate 8 is formed by the surface grinding or the surface polishing (FIG. 6G), since the other surfaces 8a and 8b are formed by the concave portion 2a of the upper mold 2, it is possible to reflect the high accuracy of the concave portion 2a on the surface accuracy of the upper surface 8a and the side surface 8b of the cover glass plate 8. For example, it is possible to perform molding such that the boundary between the upper surface 8a and the side surface 8b is a smooth curved surface. Hence, in the configuration of the present embodiment, it is possible to control and enhance the accuracy of the surfaces 8a and 8b other than the lower surface 8c of the cover glass plate 8. This configuration is particularly effective for the molding of glass that is difficult to control and that has a high viscosity.

The shape of the upper surface 8a of the cover glass plate 8 is determined by the shape of the concave portion 2a filled with the molten glass 3. Hence, as shown in FIG. 6B, the surface shape of part (or the whole) of the concave portion 2a is curved, and thus it is possible to curve the surface shape of part (or the whole) of the upper surface 8a of the cover glass plate 8. Thus, in the configuration of the present embodiment, it is possible to easily satisfy needs for changing, in specifications, the surface of the cover glass plate 8 from a flat surface to a curved surface.

Although the upper surface 8a and the side surface 8b are formed to be mirror surfaces, and this reduces the releasability of the upper mold 2, the releasability of the upper mold 2 is improved by the presence of the overlap portion 7b. Hence, it is possible to stably keep the state where the preform 7 is placed on the lower mold 1 after the press step (C), with the result that it is easy to pick up the preform 7 from the lower mold 1. When in the press step (C), the external surface Sb (FIG. 6B) of the upper mold 2 in contact with the overlap portion 7b is roughened as compared with the internal surface Sa (FIG. 6B) of the concave portion 2a, since a rough surface portion is separated by a glass contraction action after the completion of the molding, and thus the release of the contact surface of the preform is facilitated, it is possible to effectively enhance the releasability of the preform 7.

In the present embodiment, it is assumed that the size of the cover glass plate 8 is height×width×thickness (d1)=80×100×0.7 (mm) The thickness d1 (FIG. 6F) of the cover glass plate 8 is preferably 0.2 to 1.5 mm, and is more preferably 0.7 to 1.0 mm. In terms of balance with the thickness d1 of the molded main body 7a, the thickness d2 (FIG. 6F) of the overlap portion 7b located below the molded main body 7a is preferably about 0.5 to 1.0 mm. When the overlap portion 7b is excessively thin, it is easily broken, and the accuracy of the shape of the side surface 8b is reduced. On the other hand, when the overlap portion 7b is excessively thick, it takes more time to perform the surface grinding and the surface polishing. As the volume is increased, the amount of shrinkage is increased, and thus the molding surface is likely to be degraded. When the overlap portion 7b is prevented from being produced, a space is produced within the concave surface of the upper mold, and thus high accurate molding is unlikely to be performed, with the result that it is difficult to control the volume so as to perform stable molding.

### LIST OF REFERENCE SYMBOLS

1 lower mold
1f flat surface portion
1a concave portion
2 upper mold
2a concave portion
3 molten glass
4 heater
5 blade
6 platinum nozzle
7, 7A, 7B preform
7a molded main body
7b overlap portion
7s contact surface
8 cover glass plate
8a upper surface
8b side surface
8c lower surface
9 external mold
9a inner wall surface
9h opening portion
T1 concave portion
T2 convex portion
S1 first surface (molding surface)
S2 second surface (processed surface)
Sa internal surface
Sb external surface

1. A method of manufacturing a cover glass plate, the method comprising:
a drop step of dropping molten glass onto a lower mold;
a press step of pressing the molten glass on the lower mold with an upper mold having a concave portion so as to fill the concave portion of the upper mold with the molten glass and of overlapping the concave portion to an area between the upper mold and the lower mold so as to form a preform formed with a molded main body having a first surface to which a shape of the concave portion of the upper mold is transferred and an overlap portion having a second surface which is a portion other than the molded main body and to which a shape of the lower mold is transferred; and
a processing step of removing all the overlap portion from the preform.

2. The method of manufacturing a cover glass plate according to claim 1,
wherein in the press step, an upper surface and a side surface of the cover glass plate are formed with the concave portion of the upper mold, and in the processing step, surface grinding or surface polishing is performed on the second surface so as to form a lower surface of the cover glass plate.

3. The method of manufacturing a cover glass plate according to claim 2,
wherein in the press step, the lower mold has a concave portion, and a concave portion and a convex portion are formed in the second surface of the overlap portion.

4. The method of manufacturing a cover glass plate according to claim 3,
wherein in the press step, the convex portion is provided in an outermost circumference of the second surface.

5. The method of manufacturing a cover glass plate according to claim 4,
wherein an area of the convex portion on the second surface is one-fourth or more the entire second surface.

6. The method of manufacturing a cover glass plate according to claim 4,
wherein in the press step, the rectangular concave portion is provided in the second surface, and the convex portion is provided over an entire region of the outermost circumference of the second surface so as to surround the concave portion.

7. The method of manufacturing a cover glass plate according to claim 3,
wherein a shape of the concave portion of the second surface is a circular shape, a square shape, a honeycomb shape or a mesh shape.

8. The method of manufacturing a cover glass plate according to claim 3,
wherein the area of the convex portion on the second surface is one-half or less an area of the concave portion on the second surface.

9. The method of manufacturing a cover glass plate according to claim 3,
wherein a side surface of the concave portion of the second surface has a draft taper shape of three degrees or more with respect to a normal to a bottom surface of the concave portion.

10. The method of manufacturing a cover glass plate according to claim 1,
wherein a surface shape of a part or a whole of the concave portion of the upper mold is curved, and a surface shape of a part or a whole of the first surface is curved.

11. The method of manufacturing a cover glass plate according to claim 1,
wherein in the press step, a surface of the upper mold in contact with the overlap portion is roughened as compared with a surface of the concave portion of the upper mold.

12. The method of manufacturing a cover glass plate according to claim 1,
wherein in the press step, an external mold is arranged between the upper mold and the lower mold, and spread of the overlap portion is restricted by the external mold.

13. The method of manufacturing a cover glass plate according to claim 1,
wherein the cover glass plate is a cover glass plate for protecting an electronic device.
